(19) United States
(12) Patent Application Publication
(10) Pub. No.: US 2007/0159093 A1
(43) Pub. Date: Jul. 12, 2007

(54) LIGHT EMITTING APPARATUS

(75) Inventors: Osamu Yuki, Tokyo (JP); Hideo Mori, Yokohama-shi (JP); Ryuichiro Isobe, Kawasaki-shi (JP); Yoichi Osato, Yokohama-shi (JP); Hiroyuki Kitayama, Isehara-shi (JP); Toshinori Hasegawa, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/610,025

(22) Filed: Dec. 13, 2006

(30) Foreign Application Priority Data
Dec. 22, 2005 (JP) 2005-370092

(51) Int. Cl. H05B 33/00

(52) U.S. Cl. 313/512; 313/503

(57) ABSTRACT

A light emitting apparatus which can protect a light emitting device from external stress, etc. The light emitting apparatus includes a light emitting device, a housing, and a protective plate. A filler is disposed in a space between the light emitting device and the protective plate.

### BACKGROUND OF THE INVENTION

1. Field of the Invention

The present invention relates to a light emitting apparatus including a housing and a light emitting device, such as an organic light emitting device (organic EL (electroluminescent) device), which has a light emitting layer disposed between a pair of electrodes.

2. Description of the Related Art

A display using an organic EL device in a display portion is developed.

Patent Document 1 (Japanese Patent Laid-Open No. 2001-100641) discloses a light emitting apparatus including an organic EL device. The organic EL device containing a pixel electrode, a light emitting layer, and a counter (common) electrode is supported by a housing.

Even in the state of the organic EL device being supported by the housing, when an impact is externally applied (e.g., when an operator hits a display surface against some hard object), the organic EL device may be damaged or broken.

According to Patent Document 1, the organic EL device is disposed on a first base plate.

In such a structure, when an impact is externally applied, the organic EL device may be broken due to the impact directly transmitted from the first base plate.

Further, when the first base plate is bent by application of stress other than impact, the organic EL device may also be broken in some cases.

### SUMMARY OF THE INVENTION

In view of the state of the art described above, the present invention provides a light emitting apparatus capable of protecting an organic EL device from impact and stress.

More specifically, the present invention provides a light emitting apparatus including a light emitting device having a pair of electrodes, a light emitting layer disposed between the pair of electrodes, and a protective layer covering the pair of electrodes and the light emitting layer, and a housing. The light emitting apparatus further includes a protective plate adapted to protect the light emitting device. The light emitting device is supported within or by the housing with the light emitting device and the protective plate arranged with a space therebetween, and a filler is disposed in the space.

Impact and stress applied to the protective plate are damped by the filler, whereby the light emitting device can avoid being damaged or broken.

Further, the presence of the filler in the space acts to prevent extraneous light from being reflected between the protective layer formed in the light emitting device and the protective plate. As a result, viewability of the light emitting apparatus can be improved.

Thus, in the light emitting apparatus according to the present invention, the light emitting device and the protective plate are spaced from each other, and a filler layer is disposed between the light emitting device and the protective plate.

With that arrangement, it is possible to damp the impact and stress applied to the protective plate by the filler, and to avoid breakage of the light emitting device.

If air is filled in the space between the protective layer formed in the light emitting device and the protective plate, extraneous light is reflected at the interface between the protective layer and the air and at the interface between the protective plate and the air. In contrast, in the light emitting apparatus according to the present invention, since the filler is disposed in the space, reflection of extraneous light can be avoided. As a result, viewability is improved for the reason that the filler has a higher refractive index than air.

More specifically, a refractive index of the filler is set to be not larger than a refractive index of the protective plate and not smaller than a refractive index of the protective layer.

The light emitting apparatus can further include an antireflective layer at a position closer to a light taking-out side than the protective layer.

The term “antireflective” used herein means the function of preventing at least such a phenomenon that extraneous light having entered the light emitting device through the protective layer is reflected inside the light emitting device and goes out of the light emitting device again.

The antireflective layer can be directly disposed on the protective layer. The direct disposition of the antireflective layer on the protective layer includes the case of bonding the antireflective layer to the protective layer by using an adhesive.

Further, the antireflective layer can be disposed on a surface of the protective plate on a side facing the protective layer. Alternatively, the antireflective layer may be disposed on a surface of the protective plate, which is positioned oppositely away from the surface of the protective plate on the side facing the protective layer.

The antireflective layer can be a color filter or a circular polarization member which is constituted by a linear polarization member and a phase shift member.

The term “antireflective layer” used herein means a layer which is positioned closer to the light taking-out side than the protective layer.

More specifically, in a light emitting device including one electrode, a semi-transreflective layer, a light emitting layer, and the other electrode which are arranged successively (including the case where they are arranged in a mutually contacted relation) in a direction away from the light taking-out side, for example, the light emitting device has a cavity structure, but does not have in itself the antireflective layer. Herein, the one electrode means an electrode disposed closer to the light taking-out side, and the other electrode means an electrode disposed closer to the light reflecting side.

Stated another way, the light emitting device does not have in itself the antireflective layer at a position closer to the light taking-out side than the protective layer disposed on the one electrode.

Even when the light emitting device used in the light emitting apparatus according to the present invention is a light emitting device having the cavity structure, the antireflective layer can be disposed at a position closer to the light taking-out side than the protective layer. In such a case, a reflection preventing effect due to the cavity structure can be obtained in addition to a reflection preventing effect due to the antireflective layer.

The protective plate is fixed to the housing from the viewpoint of realizing a simpler structure.

The light emitting device can be arranged in a display portion of the light emitting apparatus. The light emitting apparatus having such an arrangement can be practiced as a display in various types of apparatuses. The display can be used, for example, in an image pickup apparatus having a display portion and an image pickup portion (e.g., a digital still camera or a digital video camera), and in a control panel for PC, TV, or an electrophotographic image forming apparatus.

Further, the term “light emitting device” means a light emitting device including at least a pair of electrodes and a light emitting layer which is disposed between the pair of electrodes and which emits light. When the light emitting layer is a layer made of an organic compound, the light emitting device used in the present invention can be practiced as an organic EL device. Also, when the light emitting layer is a layer made of an inorganic compound, the light emitting device used in the present invention can be practiced as an inorganic EL device.

The light emitting device can be held on the housing in a directly or indirectly supported manner.

Further features of the present invention will become apparent from the following description of exemplary embodiments with reference to the attached drawings.

### BRIEF DESCRIPTION OF THE DRAWINGS

FIG. 1 is a schematic view, partly sectioned, of an image pickup apparatus according to a first embodiment of the present invention.

FIG. 2 is a schematic sectional view of an organic EL device as one example of a light emitting device according to the first embodiment of the present invention.

FIG. 3 is a schematic view, partly sectioned, of an image pickup apparatus according to a second embodiment of the present invention.

### DESCRIPTION OF THE EMBODIMENTS

### First Embodiment

A light emitting apparatus according to a first embodiment of the present invention is featured in that the light emitting apparatus includes a light emitting device, a housing, and a protective plate, and that a filler is disposed in a space between the light emitting device and the protective plate.

With those features, stress externally applied to the protective plate is damped by the filler and the light emitting device is protected from being broken or damaged.

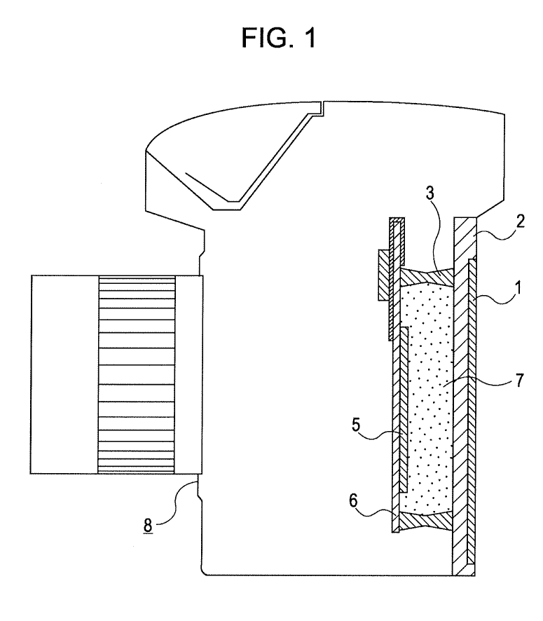

FIG. 1 is a schematic view, partly sectioned, of a digital camera in which the light emitting apparatus according to the first embodiment of the present invention is employed as an image pickup apparatus.

Reference numerals 1 denotes a protective plate, 2 denotes a housing, 3 denotes a side wall, 5 denotes a light emitting device, 6 denotes a base member, 7 denotes a filler, and 8 denotes the entire digital camera. The light emitting apparatus is used, in this non-limiting example, in a display portion of the digital camera. An operator (viewer) can see an image and characters displayed on a display surface from the right side as viewed on the drawing sheet.

The light emitting device 5 is disposed on the base member 6, and the base member 6 including the light emitting device 5 is fixed to the housing 2 through the side walls 3. In FIG. 1, a part of the housing 2 is illustrated in enlarged scale by a thick zone to more clearly show an area where the side walls 3 are joined to the housing 2.

The protective plate 1 is disposed in the part of the housing 2, which is illustrated in enlarged scale by a thick zone. More specifically, the protective plate 1 is arranged in adjacently opposite relation to the housing 2 such that peripheral edges of the protective plate 1 are positioned in fitting relation to a groove formed in the housing 2.

A space is defined between the light emitting device 5 and the protective plate 1, and the filler 7 is disposed in the space.

The protective plate 1 serves to protect the light emitting device 5 from an externally applied impact (e.g., stress applied upon touching by a user). The material and thickness of the protective plate 1 are not limited to particular ones so long as high light transmissivity is obtained. The protective plate 1 is formed of, for example, an acrylic plate. In addition, the protective plate 1 may be covered with a film affixed from the outer side of the light emitting apparatus.

The thickness of the space (in the left-and-right direction as viewed on the drawing sheet) is in the range of about 10 μm to 5 mm. Such a value of the space thickness is selected as a distance sufficient to keep the protective plate 1 from reaching the light emitting device 5 even when the protective plate 1 is deformed with application of an impact from the exterior. The filler 7 is disposed in the space. The space thickness may be set to a value ensuring that the protective plate 1 is kept from reaching the light emitting device 5 even when the protective plate 1 is deformed in a state of the filler 7 being disposed.

The filler 7 is made of a material having high light transmissivity.

Further, the refractive index of the filler 7 is set to the range of 1.2 to 2.0. The reason is as follows. Assuming, for example, that air having the refractive index of 1 is filled in the space (namely, when the filler is not disposed in the space), reflection occurs at the interface between the light emitting device and the air and at the interface between the air and the protective plate because of a large difference in the refractive index between different mediums.

Thus, the refractive index of the filler 7 is set to a value close to that of the protective plate 1 and that of a protective layer (described later). In one example, the protective layer is made of silicon nitride, and the protective plate 1 is made of acrylic.

Moreover, the refractive index of the filler 7 is preferably selected to a value between the refractive indexes of the protective plate and the protective layer and is more preferably set to a middle value between the refractive indexes of the protective plate and the protective layer.

The above point is also required in the case where the protective layer is made of silicon nitride or silicon oxynitride and the protective plate is made of acrylic. In that case, the refractive indexes of silicon nitride, silicon oxynitride, and acrylic are respectively 1.79, 1.46 and 1.49. Therefore, the refractive index of the filler 7 is set to the range of 1.46 to 1.79.

The filler 7 has high moisture resistance. As the moisture resistance, water vapor transmissivity of the filler is set to the range of 1.0×10⁻¹⁵ to 1×10⁻⁹.

Also, the filler 7 has high thermal conductivity. The filler having high thermal conductivity is able to more effectively absorb heat generated from the light emitting device and radiate the absorbed heat from the light emitting device.

In consideration of those requirements, the filler 7 can be made of, for example, silicone oil or a fluorine organic compound.

The side walls 3 may be integral with the base member 6 or with the housing 2. As an alternative, the side walls 3 may be separate from both the base member 6 and the housing 2.

The side walls 3 may specify the direction of thickness of the space. In FIG. 1, the direction of thickness of the space corresponds to the left-and-right direction as viewed on the drawing sheet.

When the filler is a gel-like or liquid material, the side walls 3 may serve to prevent the filler from leaking out of the space. When the filler is solid and will not leak out of the space, the side walls 3 can be dispensed with. Even in such a case, the side walls 3 may be provided.

The base member 6 serves to hold the light emitting device 5. The base member 6 is formed of, e.g., a glass substrate.

The light emitting apparatus includes one or more light emitting devices. When the light emitting apparatus include a plurality of light emitting devices, each light emitting device can be utilized as a pixel. In other words, when an image and characters are displayed on the display surface, the light emitting devices are preferably utilized as pixels.

When the light emitting apparatus includes a plurality of light emitting devices, respective pixels (respective light emitting devices) are controlled to be able to emit light or not emit light independently of each other. Such control can be realized by using any of various types of driving means and method, e.g., passive driving and active driving. Depending on the driving means used, the light emitting device may include in itself a switching device, e.g., TFT.

The light emitting apparatus according to this first embodiment is assumed to be used as an image display portion of a digital camera, and therefore it includes a plurality of light emitting devices. The presence of a plurality of light emitting devices is not explicitly shown in the drawing.

The light emitting device 5 is constituted by at least a pair of electrodes and a light emitting layer disposed between the pair of electrodes.

When the light emitting device 5 is an organic EL device, components of the organic EL device include at least a lower electrode, an organic light emitting layer, and an upper electrode. Between the lower electrode and the upper electrode, other various layers, such as a hole injection layer, a hole transport layer, an electron blocking layer, a hole blocking layer, an electron transport layer, and an electron injection layer, can be disposed, as required, in addition to the organic light emitting layer. Further, the light emitting layer may be a single layer, or it may be made up of plural layers, including the case where the interface between two adjacent layers emits light.

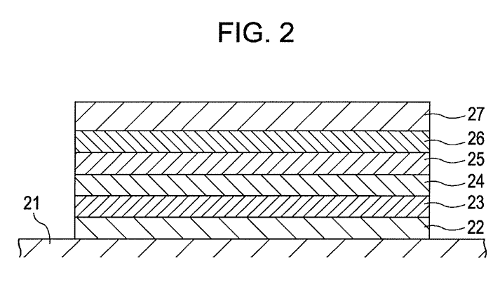

FIG. 2 is a schematic sectional view showing one example of the organic EL device.

The organic EL device is constituted by a base member 21, a lower electrode 22, a hole transport layer 23, a light emitting layer 24, a electron transport layer 25, an upper electrode 26, and a protective layer 27.

The protective layer 27 is coated on the upper electrode 26, as shown, to cover the light emitting device.

The protective layer 27 is made of, e.g., silicon nitride or a silicon oxynitride.

A cavity structure can be obtained, for example, by interposing a semi-transreflective layer (not shown) between the electron transport layer 25 and the upper electrode 26.

The lower electrode 22 can be made of a material having high reflectivity, e.g., Ag or Al. As an alternative, it can also be made of a material having high transparency. In the case using the material having high transparency, a reflecting member is additionally provided.

The upper electrode 26 can be made of a material having high transparency, e.g., ITO or IZO. As an alternative, it can also be made of a semi-transparent material, e.g., a half-mirror.

In the light emitting apparatus according to this first embodiment, the upper electrode is arranged on the right side of the light emitting device denoted by 5 in FIG. 1, as viewed on the drawing sheet, i.e., on the display side nearer to the viewer, and the lower electrode is arranged on the left side of the light emitting device 5 in FIG. 1. The upper electrode and the lower electrode are both not visible in FIG. 1.

### Second Embodiment

A light emitting apparatus according to a second embodiment of the present invention is featured in that an antireflective layer is disposed between a protective layer and a protective plate. The other construction is the same as that of the first embodiment.

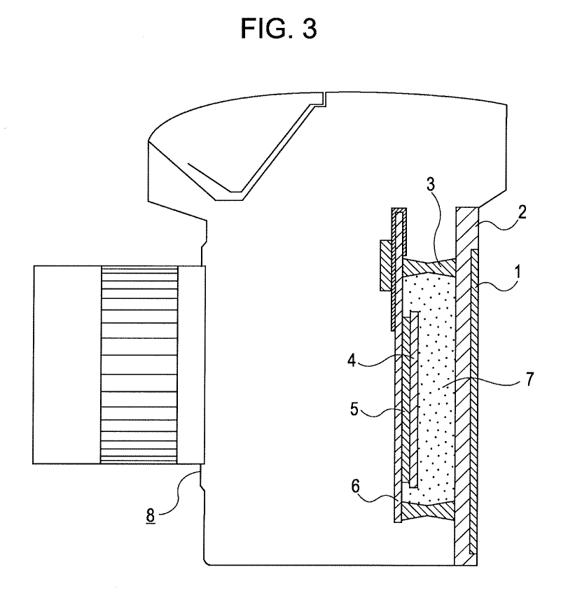

FIG. 3 is a schematic view, partly sectioned, of a digital camera in which the light emitting apparatus according to the second embodiment of the present invention is employed as an image pickup apparatus.

In FIG. 3, an antireflective layer 4 is shown as being disposed in contact with the light emitting device 5. More specifically, since the light emitting device 5 has a protective layer at the top thereof, the antireflective layer 4 is disposed on the protective layer in this second embodiment. With such an arrangement that the antireflective layer is disposed between the protective layer and the protective plate, since the antireflective layer is positioned closer to the light taking-out side than the protective layer, reflection of extraneous light by the protective surface can be avoided.

The antireflective layer 4 may be bonded to the protective layer by using an adhesive.

The antireflective layer 4 can be a color filter or a circular polarization member (e.g., a circular polarization plate). The circular polarization member is constituted, for example, by a combination of a linear polarization member and a phase shift member. The phase shift member is, e.g., a λ/4 member (specifically, a λ/4 plate).

Instead of arranging the antireflective layer 4 in contact with the protective layer, the antireflective layer may be disposed, alternatively, away from the protective layer or in contact with the protective plate. In such a case, the antireflective layer may be disposed on one surface of the protective plate which is positioned within the space, i.e., a surface of the protective plate positioned to face the light emitting device, or on the other opposite surface of the protective plate, i.e., the outermost surface of the light emitting apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-370092 filed Dec. 22, 2005, which is hereby incorporated by reference herein in its entirety.

What is claimed is:

1. A light emitting apparatus including:
a light emitting device having a pair of electrodes, a light emitting layer disposed between the pair of electrodes, and a protective layer covering the pair of electrodes and the light emitting layer;
a housing supporting the light emitting device;
a protective plate adapted to protect the light emitting device, with the light emitting device and the protective plate arranged with a space therebetween; and
a filler disposed in the space.

2. The light emitting apparatus according to claim 1, wherein a refractive index of the filler is not larger than a refractive index of the protective plate and not smaller than a refractive index of the protective layer.

3. The light emitting apparatus according to claim 1, further including an antireflective layer disposed at a position closer to a light taking-out side than the protective layer.

4. The light emitting apparatus according to claim 3, wherein the antireflective layer is disposed on the protective layer.

5. The light emitting apparatus according to claim 3, wherein the antireflective layer is disposed on a surface of the protective plate on a side facing the protective layer.

6. The light emitting apparatus according to claim 3, wherein the antireflective layer is disposed on a surface of the protective plate opposite from the protective layer.

7. The light emitting apparatus according to claim 3, wherein the antireflective layer is a color filter.

8. The light emitting apparatus according to claim 3, wherein the antireflective layer is a circular polarization member comprising a linear polarization member and a phase shift member.

9. The light emitting apparatus according to claim 1, wherein the protective plate is fixed to the housing.

10. A display apparatus, comprising:
a display device having a display portion; and
a light emitting apparatus disposed in the display portion, the light emitting apparatus comprising:
a light emitting device having a pair of electrodes, a light emitting layer disposed between the pair of electrodes, and a protective layer covering the pair of electrodes and the light emitting layer;
a housing supporting the light emitting device;
a protective plate adapted to protect the light emitting device, with the light emitting device and the protective plate arranged with a space therebetween; and
a filler disposed in the space.

11. An image pickup apparatus, comprising:
an image pickup device having a display portion; and
a light emitting apparatus disposed in the display portion of the image pickup device, the light emitting apparatus comprising:
a light emitting device having a pair of electrodes, a light emitting layer disposed between the pair of electrodes, and a protective layer covering the pair of electrodes and the light emitting layer;
a housing supporting the light emitting device;
a protective plate adapted to protect the light emitting device, with the light emitting device and the protective plate arranged with a space therebetween; and
a filler disposed in the space.

12. A light emitting apparatus, comprising:
a light emitting device having a pair of electrodes, a light emitting layer disposed between the pair of electrodes, and a protective layer covering the pair of electrodes and the light emitting layer;
a housing supporting the light emitting device;
protective means for protecting the light emitting device, with a space provided between the light emitting device and the protective means; and
a filler disposed in the space.

13. The light emitting apparatus according to claim 12, wherein a refractive index of the filler is not larger than a refractive index of the protective means and not smaller than a refractive index of the protective layer.

14. The light emitting apparatus according to claim 12, further including an antireflective layer disposed at a position closer to a light taking-out side than the protective layer.

15. The light emitting apparatus according to claim 14, wherein the antireflective layer is disposed on the protective layer.

16. The light emitting apparatus according to claim 14, wherein the antireflective layer is disposed on a surface of the protective means on a side facing the protective layer.

17. The light emitting apparatus according to claim 14, wherein the antireflective layer is disposed on a surface of the protective means opposite from the protective layer.

18. The light emitting apparatus according to claim 14, wherein the antireflective layer is a color filter.

19. The light emitting apparatus according to claim 14, wherein the antireflective layer is a circular polarization member comprising a linear polarization member and a phase shift member.

20. The light emitting apparatus according to claim 12, wherein the protective means is fixed to the housing.
